(19) United States
(12) Patent Application Publication
(10) Pub. No.: US 2006/0015662 A1
(43) Pub. Date: Jan. 19, 2006

(54) Digital camera with USB storage key for storing data

(75) Inventors: Timothy Alan Dietz, Austin, TX (US); Walid M. Kobrosly, Round Rock, TX (US); Nadeem Malik, Austin, TX (US)

Correspondence Address: International Business Machines;Intellectual Property Law, 11400 Burnet Road, Austin, TX, 78758, US

(73) Assignee: International Business Machines Corporation, Armonk, NY (US)

(21) Appl. No.: 10/891,768

(22) Filed: Jul. 15, 2004

(51) Int. Cl. G06F 13/12

(52) U.S. Cl. 710/62

(57) ABSTRACT

A system, method, and related computer program for storing digital camera data directly onto a detachable USB storage key in the digital camera. The present invention allows a user to store digital photographs taken with a digital camera directly onto the USB storage key and transfer said storage key and the data contained thereon to another computer controlled instrument, such as a PDA, camcorder, personal computer, or a second digital camera, without the use of a cable. The digital camera has a slot for operatively receiving a memory card for storage of digital photographs to be taken by said camera. The digital camera has a USB connection slot formed in the body of the camera adapted to receive a USB storage key. The USB key drive in the camera is accessible through said USB connection slot. A separatable USB storage key received in said USB connection slot and connected to said USB key drive stores data from said camera on the USB key. This invention allows a user more flexibility in storing digital photographs, and transferring stored data easily and quickly to another computer controlled instrument.

### TECHNICAL FIELD

The present invention relates to computer controlled consumer electronics devices or instruments, such as digital cameras, and specifically to the storage of digital pictures directly onto a USB storage key inserted into the USB connection slot in said camera. This invention also relates to the transfer of the stored data on the USB storage key to a computer controlled instrument, such as a PDA, camcorder, personal computer, or a second digital camera without the use of a cable.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years to now come into great demand in the marketplace.

The rapid expansion in the capacity of computers to perform support functions, the greater and greater miniaturization of computers, as well as reduction in costs to perform memory and computer operations has opened the door for computer controlled instrumentation. A key aspect of this expansion has been lower and lower cost memory. In recent years, this has been manifested in flash memory cards and sticks. At the current technology stage, these memory cards and sticks are detachably inserted into the computer controlled electronic instruments to provide an extra memory capacity of from one half to four to five gigabytes.

Memory cards use a flash memory that is based upon EEPROM (electrically erasable programmable read only memory) grid chips. Flash memory EEPROM works much faster than conventional EEPROM. Instead of erasing one byte at a time, it erases an entire block or an entire chip at a time and then rewrites. Smartmedia and Compactflash provide the “electronic film” for digital cameras while the Sony memory stick is quite popular in digital cameras and for computer controlled video games. These high capacity memory cards and sticks have been performing hard drive storage functions for the above-described computer controlled electronic instruments. In this connection, the SSFDC (solid state floppy disc card) developed by Toshiba, Inc. may function as the above-described Smartmedia card. Similarly, the above CompactFlash is a small circuit board with at least one flash memory chip and a dedicated controller chip encased in a housing or shell.

With this rapid expansion of the use of detachable memory cards for an increasing variety of computer controlled electronic instruments, the cards themselves are becoming relatively ubiquitous. The memory cards may be in or on the desks and cabinets of their users. The current use of memory cards requires the attachment of a USB cable between the camera and the personal computer or other computer controlled instrument, or that the personal computer or other computer controlled instrument be equipped with a media reader that can handle the specific types of storage the camera uses.

The present invention involves the Universal Serial Bus (USB), which was originally developed in 1995 by Intel, Compaq, DEC, IBM, Microsoft, NEC, and Northern Telecom, to define an external expansion bus that simplified adding peripherals to a PC with low cost to the user. The USB, version 1.1, has a data transfer rate of 12 megabits per second (Mbps) for connecting peripherals to a microcomputer. USB can connect up to 127 peripherals, such as external CD-ROM drives, printers, modems, mice, and keyboards to the system through a single, general purpose port, which is accomplished by daisy chaining peripherals together. USB is designed to add such devices without having to shut down and restart the system. Currently, USB enjoys tremendous success in the marketplace, and most peripheral vendors are developing products to this specification. Virtually all new PCs have one or more USB ports included thereon. USB, version 2.0, offers its users an additional range of higher performance peripherals, such as video-conferencing cameras, and increases data throughput by a factor of 40, since it has a higher bandwidth. USB 2.0 has 480 Mbps bandwidth.

To better understand USB, an understanding of the roles of each of its major elements is necessary, which is described in greater detail in the article “Understanding Universal Serial Bus Part 1: USB Basics”, Embedded Systems Programming, John Canosa, Miller Freeman, San Francisco, Calif., USA, June 1997. These major elements are the host PC hardware and software, the hub, and the peripheral. The role of the system software is to provide a uniform view of I/O systems for all applications software. The system software hides hardware implementation details causing the application software to be more portable. For the USB I/O subsystem, the system software manages the dynamic attach and detach of peripherals. This phase is called enumeration, and involves communicating with the peripheral to discover the identity of a device driver that should be loaded if it has not been loaded yet. A unique address is assigned to each peripheral during enumeration to be used for run-time data transfers. During run-time, the host PC initiates transactions to specific peripherals, and each peripheral accepts its transactions and responds accordingly. The host PC software incorporates the peripheral into the system power management scheme and can manage overall system power without user interaction.

The role of the hub is to provide managed power to attached peripherals, in addition to its obvious role of providing additional connectivity for USB peripherals. The hub recognizes dynamic attachment of a peripheral and provides at least 0.5 W of power per peripheral during initialization. Under control of the host PC software, the hub may provide more device power, up to a maximum of 2.5 W, for peripheral operation. A newly attached hub will be assigned its unique address, and hubs may be cascaded up to five levels deep. During run-time, a hub operates as a bi-directional repeater and will repeat USB signals as required on upstream (towards the host) and downstream (towards the device) cables. The hub also monitors these signals and handles transactions addressed to itself. All other transactions are repeated to attached devices. A hub supports both 12 Mbps (full-speed) and 1.5 Mbps (low-speed) peripherals.

All USB peripherals must react to request transactions sent from the host PC. The peripheral responds to control request transactions sent from the host PC. The peripheral responds to control transactions that, for example, request detailed information about the device and its configuration. The peripheral sends and receives data to/from the host using a standard USB data format. This standardized data movement to/from the PC host and interpretation by the peripheral gives USB its enormous flexibility with little PC host software changes. USB peripherals can operate at 12 Mbps or 1.5 Mbps. Presently, computer systems and cameras sold in the marketplace include integrated USB ports as a general feature.

### SUMMARY OF THE PRESENT INVENTION

The present invention provides a solution to the problems related to the inflexibility or inconvenience of storing digital photographs and transferring said stored data to another computer controlled instrument. Accordingly, the present invention provides a digital camera having a USB key drive, wherein the digital camera has a slot for operatively receiving a memory card for storage of digital photographs taken by said camera. The digital camera also has a USB connection slot formed in the body of the camera adapted to receive a USB storage key. It should be understood that in order to practice the present invention, the camera manufacturers would have to build a USB port into the camera, provide an adapter for use, or manufacture a USB memory key with a non-standard plug end to fit a current camera's port. A typical port is illustrated on FIG. 1. This port has been simplified for purposes of illustration. In reality, most cameras are equipped with a USB port that allows interface with smaller and differently shaped ports or connection slots other than would fit a standard USB cable plug. Most cameras currently are accessorized with a cord that has one standard plug end, and one non-standard plug end. The USB key drive in the camera is accessible through said USB connection slot. A separatable USB storage key is received in said USB connection slot and connected to said USB key drive, whereby data from said camera is able to be stored directly on the USB key.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of a USB key drive in accordance with the present invention capable of being inserted into a computer controlled electronic instrument, i.e. a digital camera;

FIG. 2 is a diagrammatic illustration of a USB storage key in accordance with the present invention being inserted into a computer controlled electronic instrument, i.e. a digital camera;

FIG. 3 is a block diagram of a simplified control circuitry on controller integrated circuitry on an IC chip on a USB key drive in accordance with this invention;

FIG. 4 is an illustrative flowchart in accordance with this invention showing how the USB key drive stores digital photographs directly thereon; and

FIG. 5 is a flowchart of an illustrative run of the process set up in FIG. 4.

### DETAILED DESCRIPTION OF THE PREFERRED EMBODIMENT

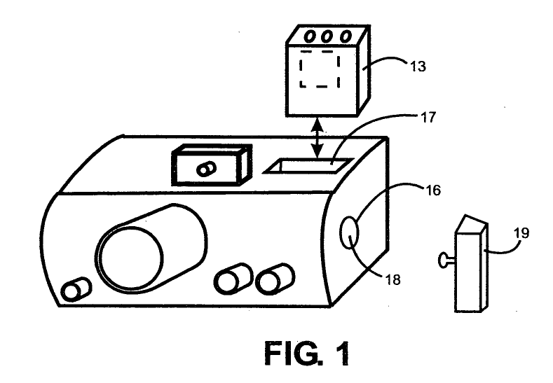

Referring to FIG. 1, a typical use of the USB key drive of the present invention in connection with a computer controlled instrument, e.g. a digital camera, is shown. The camera 16 has a slot 17 into which a typical memory card 13 may be removably inserted to operatively engage the computer system in the camera to function as a typical extended memory card, and will be hereinafter described in greater detail. The digital camera 16 also has a USB connection slot 18 adapted to receive a USB storage key 19. It should be understood that in order to practice the present invention, the camera manufacturers would have to build a USB port into the camera, provide an adapter for use, or manufacture a USB memory key with a non-standard plug end to fit a current camera's port. USB connection slot 18 or port has been simplified for purposes of illustration. In reality, most cameras are equipped with a USB port that allows interface with smaller and differently shaped connection slots or ports other than would fit a standard USB cable plug. Most cameras currently are accessorized with a cord that has one standard plug end, and one non-standard plug end. Of course, the operations to be described will be applicable to an extended memory card and computer controlled instrument co-action.

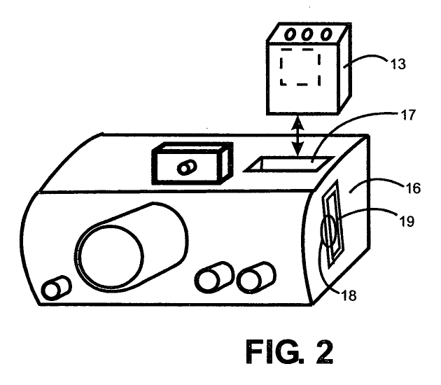

FIG. 2 shows the digital camera 16, wherein the USB storage key 19 is inserted into the USB connection slot 18, and can receive data from the digital camera 16 and store said data on the USB storage key 19. The USB storage key 19 and the data stored thereon can be transferred from the digital camera 16 to any USB capable computer controlled instrument without first downloading data to a PC or other computer system. The user can detach the USB storage key 19 and load the data onto any computer system with a USB port without the use of a cable.

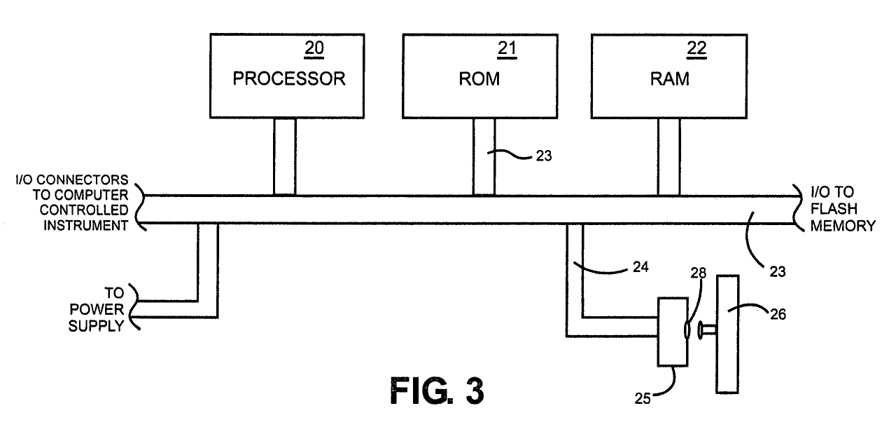

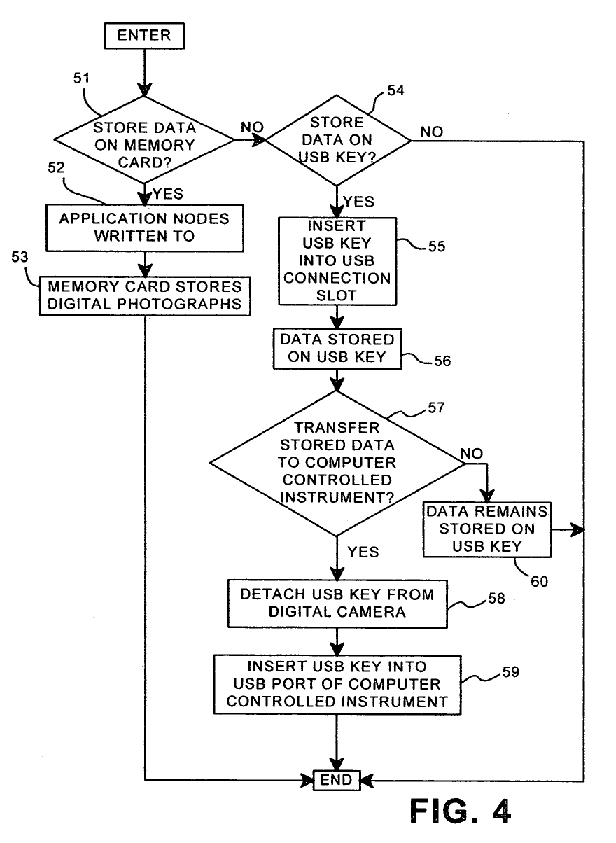

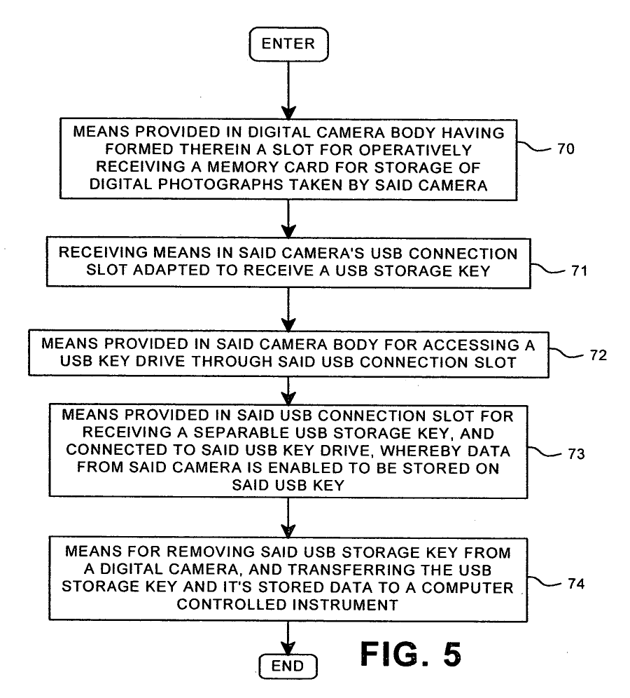

FIG. 3 is a block diagram of simplified control circuitry on controller integrated circuitry on an IC chip of a memory card 13, and the storage of data onto a USB storage key and the transfer of said stored data to a computer controlled instrument in accordance with this invention. In order to better understand the present invention, an understanding of the memory card is necessary. The controller chips provide specific purpose logic to control the access, reading and writing into the flash memory array chips. These logic or control chips contain data processors 20, operating systems stored in RAM 22 and a permanent programmable memory, and a programmable ROM 21 that may be EEPROM, e.g. flash EEPROM. All of the routines and programs may also be conventionally stored in this flash EEPROM 21. These include memory card operating systems and built-in applications that may also be conventionally stored in the RAM. The digital camera with a USB key contains a system bus 23 connected via I/O output at one end to the conventional connectors of the camera 16 to the computer controlled instrument. In accordance with the present invention, this relatively standard structure is modified to have an appropriate connection via bus 24 to a USB key drive 25, and a USB connection slot 28 for a USB storage key is present. A separable USB storage key 26 is received in said USB connection slot 28 to said USB key drive 25, whereby data from said camera 16 is enable to be stored on said USB key 26. The indicators are controlled through the controller processor 20 in accordance with the routines illustrated in FIG. 4 and FIG. 5, to be subsequently described.

There is also shown a bus branch to a power supply. Where the USB storage key is functioning already operatively inserted into the computer controlled instrument, the power supply of the instrument itself may be used for this function. By use of the present invention, the user is able to transfer stored data from a digital camera to a computer controlled instrument, e.g. a laptop computer, camcorder, personal computer, or a second digital camera.

The running of the process set up in FIG. 3 will now be described with respect to the flowchart of FIG. 4. The flowchart represents some steps in a routine that will illustrate the operation of the invention. A determination is made as to whether the user wants to store digital photographs on a traditional memory card, step 51. If Yes, the application nodes are written to, step 52. A memory card stores digital photographs taken by said digital camera, step 53. If No, a determination is made as to whether the user wants to store digital photographs on a USB storage key, step 54. If No, the process ends. If Yes, a USB storage key is inserted into a USB connection slot, step 55. The USB storage key stores data from said camera thereon, step 56. Then a determination is made as to whether the stored data on the USB storage key is to be transferred to a computer controlled instrument, step 57. If Yes, the USB storage key is detached from the digital camera, step 58. Then the USB storage key is inserted into a USB port of a computer controlled instrument, step 59, and the stored data is accessible to said computer controlled instrument. If No, the data remains stored on the USB storage key in the digital camera, step 60.

Referring now to FIG. 5, an illustrative flowchart in accordance with this invention showing how the USB storage key stores data from a digital camera directly thereon, and transfers said stored data to a computer controlled instrument without the use of a cable. Means provided in a digital camera body having formed therein a slot for operatively receiving a memory card for storage of digital photographs taken by said camera, step 70. Receiving means in said camera's USB connection slot adapted to receive a USB storage key, step 71. Means provided in said camera body for accessing a USB key drive through said USB connection slot, step 72. Means provided in said USB connection slot for receiving a separatable USB storage key, and connected to said USB key drive, whereby data from said camera is enabled to be stored on said USB key, step 73. Means for removing said USB storage key from a digital camera, and transferring the USB storage key and its stored data to a computer controlled instrument, such as a PDA, personal computer, camcorder, or a second digital camera, without the use of a cable, step 74.

Although certain preferred embodiments have been shown and described, it will be understood that many changes and modifications may be made therein without departing from the scope and intent of the appended claims.

What is claimed is:

1. A computer controlled digital camera comprising:
a camera body having formed therein a slot for operatively receiving a memory card for storage of digital photographs taken by said camera;
a USB connection slot formed in said camera body adapted to receive a USB storage key;
a USB key drive in said camera body accessible through said USB connection slot; and
a separatable USB storage key insertable into said USB connection slot and connected to said USB key drive, whereby data from said camera is enabled to be stored on said USB key.

2. The computer controlled digital camera of claim 1 wherein the stored data on the USB key is transferable to a computer controlled instrument with a device driver for a USB key.

3. The computer controlled digital camera of claim 2 wherein the computer controlled instrument with a device driver for a USB key is a PDA.

4. The computer controlled digital camera of claim 2 wherein the computer controlled instrument with a device driver for a USB key is a camcorder.

5. The computer controlled digital camera of claim 2 wherein the computer controlled instrument with a device driver for a USB key is a personal computer.

6. The computer controlled digital camera of claim 2 wherein the computer controlled instrument with a device driver for a USB key is a second digital camera.

7. A method for storing data from a computer controlled digital camera, including the steps of:
receiving a memory card for storage of digital photographs taken by a camera with a camera body having formed therein a slot for operatively receiving said memory card;
receiving a USB storage key in a camera body having a USB connection slot formed in said camera body adapted to receive said key;
accessing a USB key drive in said camera body through said USB connection slot; and
receiving a separatable USB storage key in said USB connection slot and connected to said USB key drive, whereby data from said camera is enabled to be stored on said USB key.

8. The method of claim 7 wherein the stored data on the USB key is transferable to a computer controlled instrument with a device driver for a USB key.

9. The method of claim 8 wherein the computer controlled instrument with a device driver for a USB key is a PDA.

10. The method camera of claim 8 wherein the computer controlled instrument with a device driver for a USB key is a camcorder.

11. The method camera of claim 8 wherein the computer controlled instrument with a device driver for a USB key is a personal computer.

12. The method of claim 8 wherein the computer controlled instrument with a device driver for a USB key is a second digital camera.

13. A computer program having code recorded on a computer readable medium for storing data on a computer controlled digital camera, comprising:
means in a camera body having formed therein a slot for operatively receiving a memory card for storage of digital photographs taken by said camera;
means for a USB connection slot formed in said camera body adapted to receive a USB storage key;
means for a USB key drive in said camera body accessible through said USB connection slot; and
means for a separatable USB storage key insertable into said USB connection slot and connected to said USB key drive, whereby data from said camera is enabled to be stored on said USB key.

14. The computer program of claim 13 wherein the stored data on the USB key is transferable to a computer controlled instrument with a device driver for a USB key.

15. The computer program of claim 14 wherein the computer controlled instrument with a device driver for a USB key is a PDA.

16. The computer program of claim 14 wherein the computer controlled instrument with a device driver for a USB key is a camcorder.

17. The computer program of claim 14 wherein the computer controlled instrument with a device driver for a USB key is a personal computer.

18. The computer program of claim 14 wherein the computer controlled instrument with a device driver for a USB key is a second digital camera.
